(19) United States
(12) Patent Application Publication
(10) Pub. No.: US 2013/0084547 A1
(43) Pub. Date: Apr. 4, 2013

(54) Illuminated Child's Activity Toy

(71) Applicant: Tech 4 Kids Inc., Mississauga (CA)

(72) Inventors: Bradley D. Pedersen, Mississauga (CA); Kyle Jeffs, Mississauga (CA)

(73) Assignee: Tech 4 Kids Inc., Mississauga (CA)

(21) Appl. No.: 13/627,427

(22) Filed: Sep. 26, 2012

Related U.S. Application Data
(60) Provisional application No. 61/542,768, filed on Oct. 3, 2011.

(51) Int. Cl. G09B 11/06

(52) U.S. Cl. 434/85

(57) ABSTRACT

An illuminated child's activity toy in which a housing is provided on which opaque drawing sheets can be mounted. The housing includes an illumination system that can be used to back-light the surfaces of the housing. Using a scraping tool, a child can remove the opaque material from the drawing sheet to reveal the illuminated base and optionally, a design which has been pre-printed on the drawing sheet. The illuminated toy can be viewed using 3D glasses to enhance the visual appearance of the toy. Additionally, the toy can be used as a customized nightlight of the child's own design. A novel child's activity toy is provided.

### CROSS REFERENCE TO RELATED APPLICATIONS

The present application is a nonprovisional application of U.S. Application 61/542,768 filed Oct. 3, 2011.

### FIELD OF THE INVENTION

The present invention relates to the field of activity toys for children, and in particular, relates to an illuminated drawing toy for use by a child.

### BACKGROUND OF THE INVENTION

Children enjoy drawing, painting, and playing with bright and multiple colored toys and other pieces. Numerous designs are known for providing simple activity centers or drawing tools comprising a flat board onto which paper, or the like can be attached and onto which, a child can attached letters, shaped designs, or the like, or draw free-hand to produce an image.

Furthermore, illuminated lighting systems are known for use together with a child's activity toy. In one known illuminated system, a light source is provided having a series of different colored coatings applied to the source, and then covered by a translucent white exterior coat. The exterior coat can be scrapped away to reveal the colored layers underneath, and thus create a colored pattern through which the light from the light source can shine. Use of a light source as a toy by a small child would be unsuitable, for a variety of safety reasons, as would be well understood.

Other toys are known have a lighted display. However, while illuminated activity devices are generally well received by most children, it would still be advantageous to provide additional types of illuminated activity toys, that provide unique features, and which allows a child to draw an illustration particularly adapted for display by the toys illumination system.

Moreover, many children use nightlights. It would additionally be advantageous to provide a toy wherein a child could design and create an individualized nightlight, for their own use.

### SUMMARY OF THE INVENTION

An exemplary implementation of an illuminated child's activity toy of the present invention comprises a illumination housing having an illumination system located within the housing, and which shines light to the outside of the housing creating a back-lit, illuminated surface. Preferably, the housing is structured so as to provide a plurality of back-lit, illuminated surfaces.

A series of essentially opaque drawing sheets are provided which are adapted to be located over the illuminated surface. The drawing sheets can be pre-printed with a design feature. However, the use of a drawing sheet without any design features is not excluded from the present invention. The drawing sheets include a coating material which can be scrapped off of the drawing sheet, and reveal a transparent, or translucent area, in the area where the coating material has been scrapped. This allows light to shine through the drawing sheet in the area where the coating has been removed. This creates a glowing design, and depending on the color of the light and/or the color of the transparent or translucent area, the illuminated toy emits light from the toy.

Numerous other advantages and features of the invention will become readily apparent from the following detailed description of the invention and the embodiments thereof, from the claims, and from the accompanying drawings.

### BRIEF DESCRIPTION OF THE DRAWINGS

A fuller understanding of the foregoing may be had by reference to the accompanying drawings, wherein:

FIG. 1 is a perspective view of one possible embodiment of an illuminated activity toy of the present invention;

FIG. 2 is a further view of the toy of FIG. 1 showing additional details;

FIG. 3 is a further view of the toy of FIG. 1 in two components;

FIG. 4 is a view of an illuminated toy with completed drawings sheets mounted, and unfinished drawing sheets, with a scrapping tool;

FIG. 5A is a perspective view of a drawing sheet showing an opaque substrate configured to be scraped away to create an image; and

FIG. 5B is a perspective view of a drawing sheet showing an opaque substrate configured to be scraped away to create an image.

### DETAILED DESCRIPTION OF THE PREFERRED EMBODIMENTS

While the invention is susceptible to embodiments in many different forms, there are shown in the drawings and will be described in detail herein the preferred embodiments of the present invention. It should be understood, however, that the present disclosure is to be considered an exemplification of the principles of the invention and is not intended to limit the spirit or scope of the invention and/or claims of the embodiments illustrated.

The novel features which are believed to be characteristic of the present invention, as to its structure, organization, use and method of operation, together with further objectives and advantages thereof, will be better understood from the following drawings in which a presently preferred embodiment of the invention will now be illustrated by way of example only. In the drawings, like reference numerals depict like elements.

It is expressly understood, however, that the drawings are for the purpose of illustration and description only and are not intended as a definition of the limits of the invention. Also, unless otherwise specifically noted, all of the features described herein may be combined with any of the above aspects, in any combination.

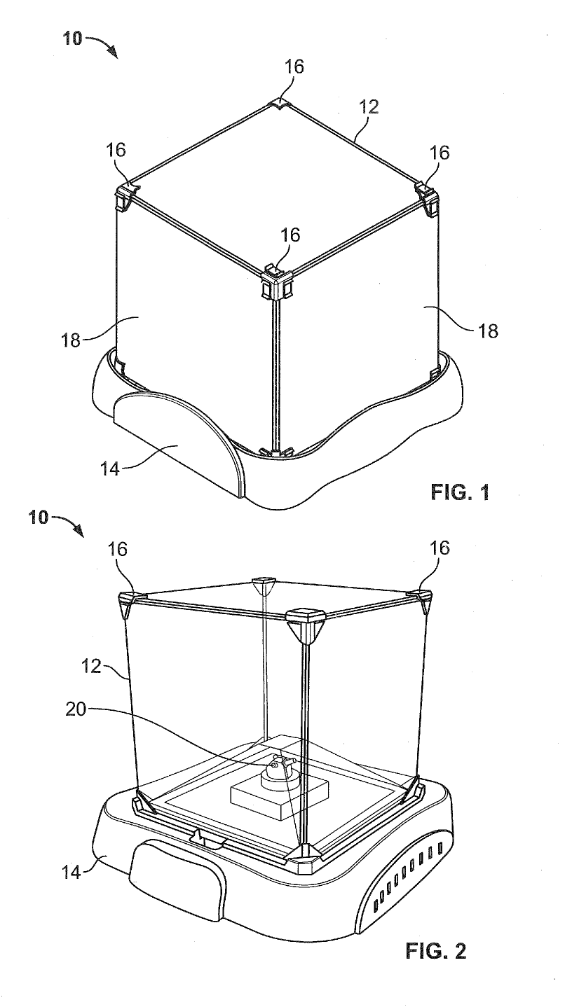

Referring to FIG. 1, an illuminated child's activity toy 10 is shown having a cube shape. The cube 12 rests on base 14. At the corners of cube 12 are attachment clips 16, which are used to hold drawing sheets 18 in place. In this example, two drawing sheets 18 are shown in place, but up to 5 drawing sheets can be fitted to the outside of cube 12.

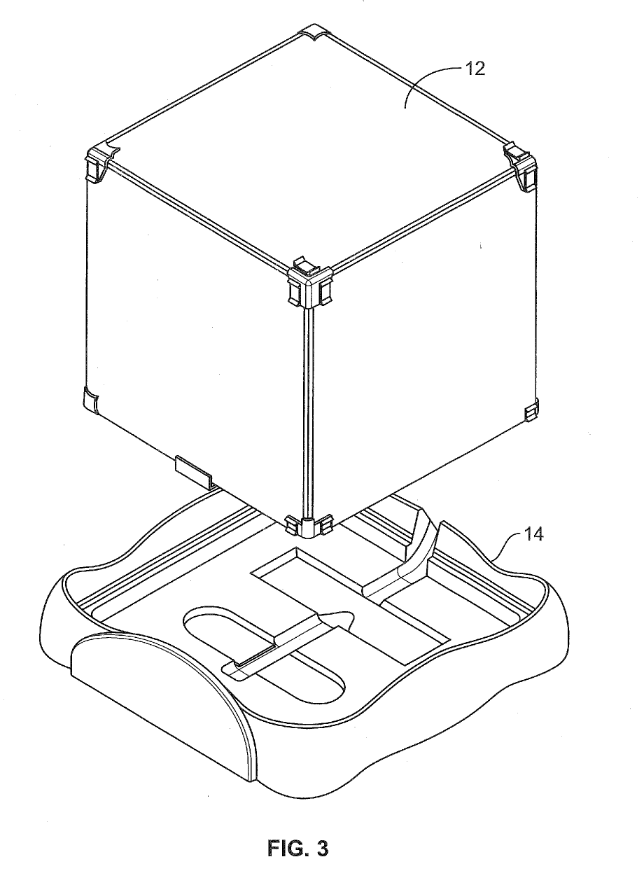

In FIG. 2, the same toy 10 is shown, wherein all drawing sheets 18 have been removed, and it can be seen that a central LED light cluster 20 is provided having 3 different colored LEDs. The LED light cluster 20 may also be covered by a frosted dome inside of the cube 12 to softener the light. The sides of cube 12 can be clear, as shown, but can alternatively be translucent, such as frosted white in color, or any other suitable color can be used. Typically, a frosted white cube is used since it will let light through, without exposing the inner working mechanisms.

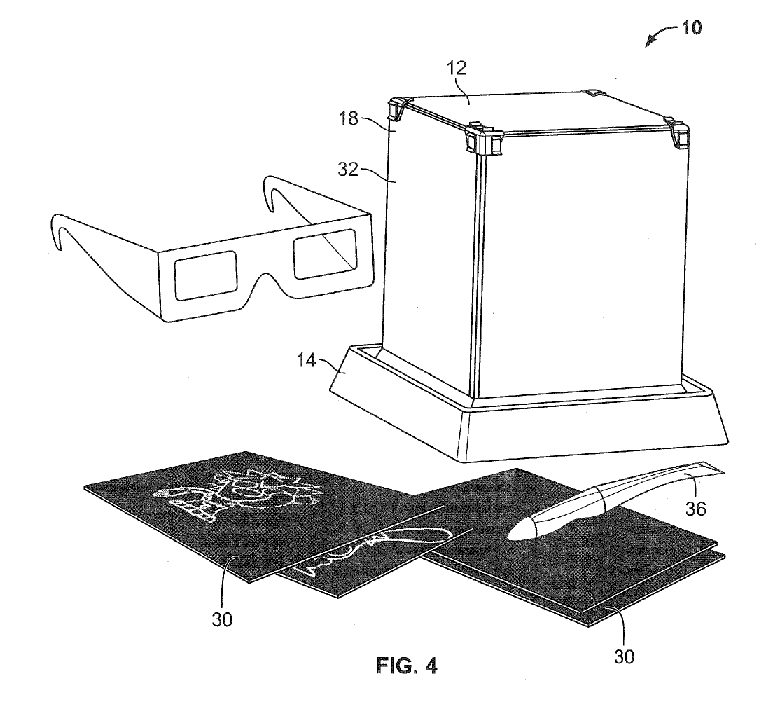

Cube 12 can be removable from base 14, as seen in FIG. 3, and a switch feature (not shown) can be included such that insertion of cube 12 into base 14 will cause the illumination system to activate.

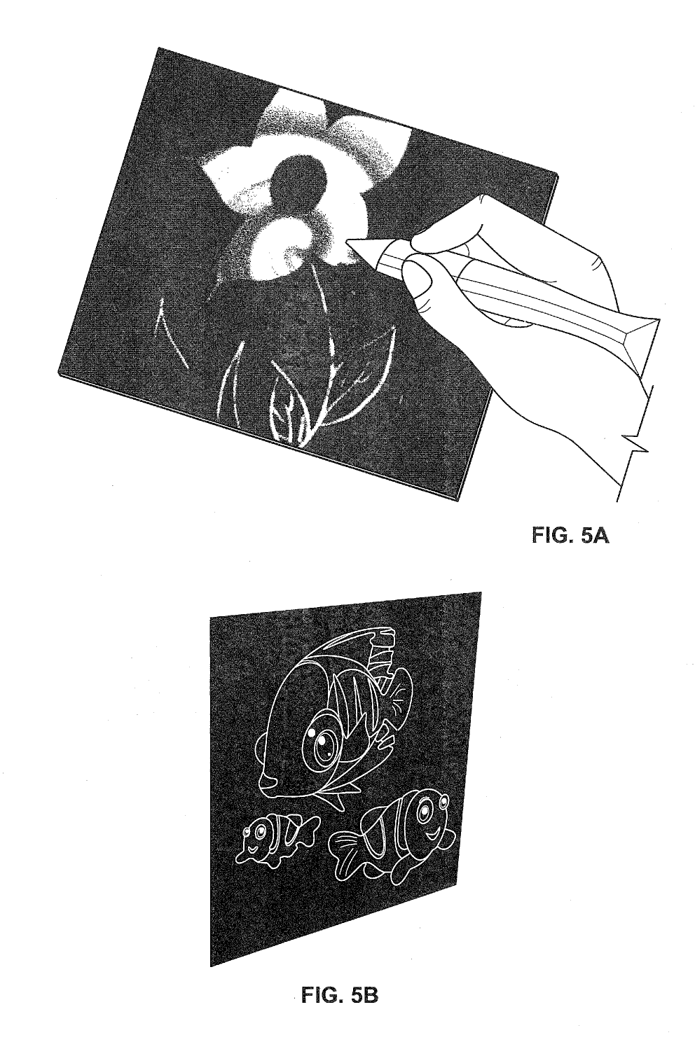

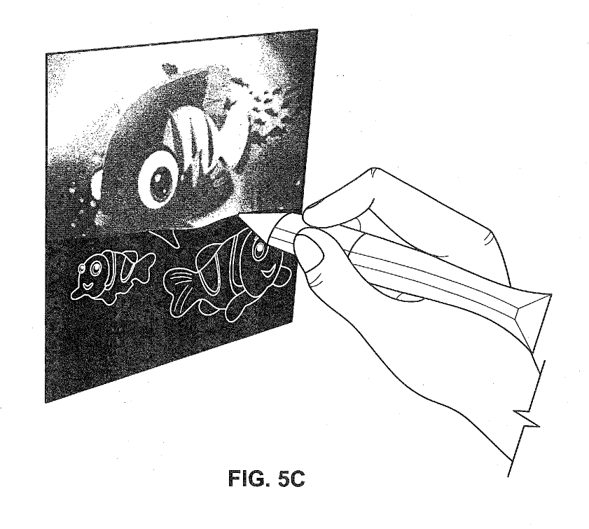

In FIG. 4, a complete toy 10 is shown having an illuminated cube 12 on which scrapped drawing sheets 18 are shown. Cube 12 sits on base 14, and toy 10 is fully illuminated so that the entire surface of scrapped drawing sheets 18 can be seen.

In front of toy 10, are four un-scrapped drawing sheets 30 having an opaque coating, and a representative design 32 printed on sheets 30. A plastic scrapping toy 36 is provided for scrapping the opaque coating from drawing sheets 30.

The housing is preferably made of plastic, and has a base section, and preferably, a plurality of illuminated surfaces. For a square design shape, at least four side surfaces, and a top surface, can be provided so as to provide 5 illuminated surfaces. For other shapes, different numbers of such surfaces can be provided. For example, the housing can be triangular, circular, or oval, and provide a corresponding number of illuminated surfaces. In general, the housing has preferably has up to 8 drawing surfaces, and more preferably, has between 2 to 6 illuminated surfaces. In a most preferred embodiment, a cube shape is used providing 5 illuminated surfaces, with the sixth surface of the cube resting on a base. The drawing sheets are made of plastic film, such as polyethylene sheets or the like, and are printed with a coating that is opaque. The coating is adapted to be scrapped off of the drawing sheet using a scraping tool. A preferred scraping tool would be a dull scraper made of plastic, for reasons of child safety. The child can scrap the coating off while the drawing sheet is held in the housing, or the drawing sheet can be removed from the housing for the scraping operation.

The plastic film base for the drawing sheet can be clear, colored, transparent, translucent, or the like, but in any case, allows light to pass through the film prior to the application of the coating material. Moreover, in one embodiment, the plastic base film can contain a pre-printed pattern of images or colors which are revealed by removal of the opaque coating material. Moreover, different areas of the scrapped drawing sheet can reveal different colors or different images.

Alternatively, the film can be of a single color (e.g. frosted white), and the child is free to design their own images and features (e.g. their name etc.) by only removing some of the coating material. The color of the illuminated features can then be varied by changing the color of the lighting source, or the like.

The coating material can be a spray painted material which adheres to the film so as to make the drawing sheet opaque, but does not adhere to the drawing sheet so well that scrapping of the coating is difficult, or not possible. A image can also be provided on top of the coating material to represent the image provided under the coating material.

By scrapping away the coating material, an illuminated image is produced, that is back-lit by the illumination system. By using colored films and/or colored lights in the illumination system, different colors are emitted or projected from the activity toy of the present invention.

In one preferred embodiment, the coloured image is viewed by the child using three dimensional (3D) imaging technology. In particular, in one preferred embodiment, the child uses a type of three dimensional imaging technology known as “Chromadepth” imaging technology, which was developed by American Paper Optics. This technique produces a 3D effect based upon differences in the diffraction of color through a special prism-like holographic film which is typically fitted into glasses worn by the viewer. Chromadepth glasses purposely exacerbate chromatic aberration and give the illusion of colors taking up different positions in space, with red being in front, and blue being in back. In more detail, the lenses of the Chromadepth glasses, are oriented sideways, so that the overall bending effect creates an image wherein it appears that parts of the scene have been shifted horizontally inwards (ie, towards the center of the user's face). In its typical configuration, the red hues are shifted more than the greens and the greens are shifted more than the blues. Thus, red elements in the 3D scene appear to converge closest to the viewer and the blue elements appear to converge the farthest away. This technique works particularly well with the sky, sea or grass as a background, and redder objects in the foreground.

Any suitably colored material can be given a 3D effect as long as the color spectrum is put into use with the foreground being in red, and the background in blue. From front to back the scheme therefore follows the visible light spectrum, from red to orange, yellow, green and blue. As a result, Chromadepth works best with artificially produced or enhanced pictures, since the color of the object indicates and controls the “depth” of the image.

An advantage of the Chromadepth technique however, is that since the Chromadepth image contains its apparent depth information all in one image. This eliminates the ghosting effect seen in other 3D imaging technique when the user view the objects or images without the appropriate 3D glasses. Thus, Chromadepth images can be viewed comfortably and clearly without using the 3D glasses, even though the 3D effect will not be perceivable without them. As such, the child can easily use the activity toy with, or without, the 3D glasses.

In the present invention, the areas scrapped from the drawing sheet are preferably colored using different colors so that the result image has a 3D effect when viewed through Chromadepth glasses.

The inventors have further found that the Chromadepth technology is enhanced if the colors selected use fluorescent pigments. As such, in a preferred embodiment, the image is viewed with Chromadepth glasses wherein at least some of the light emitted is created using fluorescent pigments.

Still more preferably, the inventors have also found that the Chromadepth technology is further enhanced if the image is viewed under Ultraviolet (UV) light.

The illumination system of the activity toy of the present invention can also be modified to supply additional features. In one embodiment, the lights in the illumination system are caused to create a “flickering” or “pulsing” effect by turning the light(s) on or off, or by changing their brightness. This creates a flickering or pulsing like effect.

Additionally, in a preferred embodiment, the illumination system can include a timer function such that it will shut off after a selected time period. When powered by batteries, this can provide a battery-conservation benefit, in the event that the toy is inadvertently left on. This feature also provides the child with a nightlight functionality wherein the light will automatically extinguish after a set time period.

In essence, the child can use the toy to produce their own, individualized nightlight.

It will be apparent that the illuminated toy of the present invention can be powered by regular household energy, but preferably, is powered by batteries. Further, the illumination system can be provided by one or more incandescent bulbs, but preferably the light is provided by one, or a plurality of LED lights. In a preferred embodiment, the LED lights can be a series of different colours, thus allowing the colour projected to be varied over time.

In one embodiment the illuminated toy includes a base having a bottom section with an interior terminal edge forming into a skirt extending upwardly from the bottom section. A walled structure is provided to sit unto the base. The walled structure has at least five surfaces formed from four side sections and a top section. The four side sections each has a lower edge. An illuminating component is positioned about a center of the base and which when activated provides a back light against an interior surface of the walled structure. And at least one sheet is included and has a drawing thereon. The sheet is capable of being secured against one of the surfaces such that when the illuminating component is activated, the back light provided is configured to shine through the surfaces illuminating the drawing.

In another aspect the at least one sheet can include an opaque substrate over a drawing wherein when the illuminating component is activated, the back light provided is configured to shine through the drawing substrate but would be blocked by the opaque substrate. In this instance, a scraper tool is provided and has an edge configured to scrape away the opaque substrate and to leave the drawing substrate thereon. The user can thus scrape away the opaque to reveal the hidden drawing. The opaque substrate can be a paint.

In other aspects the four side sections and the top section form at least four top corners about the top section and four side corners about the lower edges of the four side section. Each the four top corners and the four side corners can include a clip secured thereto. The clip has at least two grooves configured to hold the at least one sheet when the at least one sheet is positioned against one of the five surfaces. In addition, the clip could run the entire length of the edge and may be substantially formed into the side edge of each section.

In various embodiments the sheets may already be partially scraped revealing an initial picture such that when the paint is substantially removed, the drawing on the at least one sheet is a more detailed picture of said initial picture. Alternatively, the user could simply scrape a picture into the opaque substrate to reveal an image created.

As noted the at least one sheet could include a drawing that uses three dimensional imaging technology to provide a three dimensional image when viewed through three dimensional glasses.

In other aspects, the base may include a channel formed about the terminal edge of the bottom section that is sized to receive a lower edge of the four side sections of the walled structure.

In another embodiment, the illuminated toy includes a base having a bottom section with an interior terminal edge forming into a skirt extending upwardly from the bottom section and a walled structure having at least one surface formed around the walled structure. The at least one surface having a lower edge to engage the interior terminal edge of the base. An illuminating component positioned about a center of the base, which when activated provides a back light against an interior surface of the walled structure. In addition, at least one sheet is provided and which has a drawing thereon and being capable of being secured against at least a portion of the at least one surface, and wherein when the illuminating component is activated, the back light provided is configured to shine through the at least one surface illuminating the drawing. The at least one surface may be formed into a dome or formed into multiple surfaces to form a polygon shaped structure.

Preferably, the products described herein are sold as a kit containing all of the featured elements. Alternatively, various components can be individually sold, such as replacement drawing sheets, and the like.

Thus, it is apparent that there has been provided, in accordance with the present invention, an illuminated child's activity toy, which fully satisfies the goals, objects, and advantages set forth hereinbefore. Therefore, having described specific embodiments of the present invention, it will be understood that alternatives, modifications and variations thereof may be suggested to those skilled in the art, and that it is intended that the present specification embrace all such alternatives, modifications and variations as fall within the scope of the appended claims.

Additionally, for clarity and unless otherwise stated, the word “comprise” and variations of the word such as “comprising” and “comprises”, when used in the description and claims of the present specification, is not intended to exclude other additives, components, integers or steps. Further, the invention illustratively disclosed herein suitably may be practiced in the absence of any element which is not specifically disclosed herein.

Moreover, the words “substantially” or “essentially”, when used with an adjective or adverb is intended to enhance the scope of the particular characteristic; e.g., substantially planar is intended to mean planar, nearly planar and/or exhibiting characteristics associated with a planar element.

Further, use of the terms “he”, “him”, or “his”, is not intended to be specifically directed to persons of the masculine gender, and could easily be read as “she”, “her”, or “hers”, respectively.

Also, while this discussion has addressed prior art known to the inventor, it is not an admission that all art discussed is citable against the present application.

From the foregoing and as mentioned above, it is observed that numerous variations and modifications may be effected without departing from the spirit and scope of the novel concept of the invention. It is to be understood that no limitation with respect to the embodiments illustrated herein is intended or should be inferred. It is intended to cover, by the appended claims, all such modifications within the scope of the appended claims.

What is claimed is:

1. An illuminated toy comprising:
a base having a bottom section with an interior terminal edge forming into a skirt extending upwardly from the bottom section;
a walled structure having at least five surfaces formed from four side sections and a top section, the four side sections each having a lower edge;
an illuminating component positioned about a center of the base, which when activated provides a back light against an interior surface of the walled structure; and
at least one sheet having a drawing thereon and being capable of being secured against one of the surfaces, and wherein when the illuminating component is activated, the back light provided is configured to shine through the surfaces illuminating the drawing.

2. The toy of claim 1, wherein the at least one sheet includes a paint over the drawing such that the drawing is not visible when the paint is covering the at least one sheet, and the paint is configured to be scrapped away from the at least one sheet by a sharp edge.

3. The toy of claim 2, wherein the four side sections and the top section forming at least four top corners about the top section and four side corners about the lower edges of the four side sections, each of the four top corners and the four side corners having a clip secured thereto, and each clip having at least two grooves, each groove configured to hold the at least one sheet when the at least one sheet is positioned against one of the five surfaces.

4. The toy of claim 3, wherein the clips run along substantially the entire edge of the sections.

5. The toy of claim 2, wherein the at least one sheet is partially scraped revealing an initial picture such that when the paint is substantially removed, the drawing on the at least one sheet is a more detailed picture of said initial picture.

6. The toy of claim 1, wherein the at least one sheet includes a drawing that uses three dimensional imaging technology to provide a three dimensional image when viewed through three dimensional glasses.

7. The toy of claim 1, wherein the base includes a channel formed about the terminal edge of the bottom section sized to receive a lower edge of the four side sections of the walled structure.

8. The toy of claim 1, wherein the illuminating component is an LED cluster having different colored LEDs.

9. An illuminated toy comprising:
a base having a bottom section with an interior terminal edge forming into a skirt extending upwardly from the bottom section;
a walled structure having at least five surfaces formed from four side sections and a top section, the four side sections each having a lower edge;
an illuminating component positioned about a center of the base, which when activated provides a back light against an interior surface of the walled structure;
at least one sheet having an opaque substrate over a lower substrate and being capable of being secured against one of the surfaces, and wherein when the illuminating component is activated, the back light provided is configured to shine through the lower substrate but would be blocked by the opaque substrate; and
a scraper tool having an edge configured to scrape away the opaque substrate and to leave the lower substrate thereon.

10. The toy of claim 9, wherein the opaque substrate is a scapable paint.

11. The toy of claim 9, wherein the lower substrate includes a picture.

12. The toy of claim 10, wherein the at least one sheet is partially scraped revealing an initial picture such that when the opaque substrate is substantially removed, the picture on the at least one sheet is a more detailed picture of said initial picture.

13. The toy of claim 9, wherein the at least one sheet includes a picture that uses three dimensional imaging technology to provide a three dimensional image when viewed through three dimensional glasses.

14. The toy of claim 9, wherein the four side sections and the top section forming at least four top corners about the top section and four side corners about the lower edges of the four side sections, each of the four top corners and the four side corners having a clip secured thereto, and each clip having at least two grooves, each groove configured to hold the at least one sheet when the at least one sheet is positioned against one of the five surfaces.

15. The toy of claim 14, wherein the base includes a channel formed about the terminal edge of the bottom section sized to receive a lower edge of the four side sections of the walled structure.

16. The toy of claim 9, wherein the illuminating component is an LED cluster having different colored LEDs.

17. An illuminated toy comprising:
a base having a bottom section with an interior terminal edge forming into a skirt extending upwardly from the bottom section;
a walled structure having at least one surface formed around the walled structure, the at least one surface having a lower edge to engage the interior terminal edge of the base;
an illuminating component positioned about a center of the base, which when activated provides a back light against an interior surface of the walled structure; and
at least one sheet having a drawing thereon and being capable of being secured against at least a portion of the at least one surface, and wherein when the illuminating component is activated, the back light provided is configured to shine through the at least one surface illuminating the drawing.

18. The toy of claim 17, wherein the at least one sheet includes a paint over the drawing such that the drawing is not visible when the paint is covering the at least one sheet, and the paint is configured to be scrapped away from the at least one sheet by a sharp edge.

19. The toy of claim 17, wherein the at least one surface is formed into a dome or formed into multiple surfaces to form a polygon.

20. The toy of claim 19, wherein the at least one sheet is partially scraped revealing an initial picture such that when the paint is substantially removed, the drawing on the at least one sheet is a more detailed picture of said initial picture.
